(19) United States
(12) Patent Application Publication
(10) Pub. No.: US 2014/0175003 A1
(43) Pub. Date: Jun. 26, 2014

(54) FILTRATION MODULE INCLUDING HOLLOW FIBER SUPPORTS

(71) Applicants: Steven J. Gluck, Lake Jackson, TX (US); Peter E. Aerts, Hulst (NL)

(72) Inventors: Steven J. Gluck, Lake Jackson, TX (US); Peter E. Aerts, Hulst (NL)

(73) Assignee: DOW GLOBAL TECHNOLOGIES LLC, Midland, MI (US)

(21) Appl. No.: 14/115,636

(22) PCT Filed: Jun. 11, 2012
(86) PCT No.: PCT/US2012/041809

§ 371 Date: Nov. 5, 2013

Related U.S. Application Data
(60) Provisional application No. 61/503,066, filed on Jun. 30, 2011.

(51) Int. Cl. B01D 63/02

(52) U.S. Cl. CPC B01D 63/024
USPC 210/321.81

(57) ABSTRACT

A filtration module including a plurality of vertically aligned semi-permeable hollow fiber membranes, a plurality of fiber supports spaced apart and along the length of the hollow fiber membranes wherein each fiber support comprises a plurality of partitions that segment the hollow fiber membranes into multiple groupings and wherein a plurality of the groupings of one fiber support are distinct from those of another.

### TECHNICAL FIELD

The present invention is directed toward filtration modules including semi-permeable hollow fiber membranes. Representative applications for such modules include the purification of water from streams, rivers, ponds and lakes. Other examples include the treatment of municipal and industrial waste water including sewage and settling ponds. Such modules may also find use in membrane bioreactor (MBR) applications.

### BACKGROUND ART

Filtration modules commonly utilize semi-permeable hollow fiber (a.k.a. “capillary”) membranes. One classic design includes a plurality of hollow fibers extending between opposing headers. Specific examples are described in: U.S. Pat. No. 5,248,424, U.S. Pat. No. 6,214,226, U.S. Pat. No. 6,682,652 and U.S. Pat. No. 7,850,853. In an alternative design, one end of the hollow fiber membranes are potted within a header with the opposite ends unsupported and free to move. Examples of single header designs are described in U.S. Pat. No. 7,160,454 and JP 11-128692.

In operation, several modules may be interconnected to form a filtration assembly which is submerged in a tank or module encasement having a feed liquid source such as a settling pond, an aerobic activated sludge basin or an anaerobic biological water treatment basin. Filtration occurs by creating a trans-membrane pressure differential across the membrane surface, i.e. typically by drawing a vacuum from the permeate side of the membrane or by pressurizing the feed source. As a result of trans-membrane pressure, permeate flows through the pores of the membranes and is collected within a header which is sealed from the feed source. After prolonged use, suspended solids from the feed liquid accumulate on the membrane surface and form a fouling or “cake” layer that restricts or even blocks fluid flow. Conventionally, fouling and cake layers have been removed by aeration wherein bubbles scour the outer surface of the membrane. Aeration and turbulent flow conditions can result in fiber breakage or fiber entanglement. One approach for addressing fiber breakage and entanglement is through the use of a cage, web or netting that encircles one or more bundles of fibers and limits their range of motion. Examples are described in U.S. Pat. No. 6,783,008 and 7,160,454. U.S. Pat. No. 7,531,091 describes a similar approach wherein a plurality of fiber holding devices (“fiber supports”) are spaced along the length of hollow fiber membranes. Each fiber support includes a plurality of rectangular partitions that segment the fibers passing through. The partitions of each fiber support are vertically aligned with each other and collectively define adjacent vertical columns that encircle fiber bundles. In each of these approaches, the fiber supports encircle a common grouping of fibers across the entire fiber length. As a result, individual fibers within a specific grouping tend to closely associate or cluster together rather than maintain even spacing. This clustering effect makes cleaning difficult and leads to premature membrane fouling and/or clogging.

### STATEMENT OF INVENTION

In a main embodiment, the invention includes a filtration module comprising a plurality of vertically aligned, semi-permeable hollow fiber membranes extending along a length between first and second ends with at least one of end potted within a header. The module also comprises a plurality of fiber supports spaced apart and along the length of the hollow fiber membranes wherein each fiber support comprises a plurality of partitions that segment the hollow fiber membranes into multiple fiber groupings passing through the fiber support such that a plurality of the fiber groupings of at least one fiber support are distinct from those of an another fiber support. In at least one embodiment, the present invention provides a filtration module with improved hollow fiber spacing. Many additional embodiments are disclosed.

### BRIEF DESCRIPTION OF THE FIGURES

The included figures illustrate several embodiments of the subject tubesheet. The figures are not to scale and include idealized views to facilitate description. Where possible, like numerals have been used throughout the figures and written description to designate the same or similar features.

FIG. 1 is a perspective view of a filtration module.

FIG. 2 is a view of the module of FIG. 1 with the hollow fiber membranes removed.

### DETAILED DESCRIPTION

While applicable to both dual and single header designs, the present invention is particularly applicable for single header designs wherein a plurality (typically hundreds) of hollow fiber membranes (“fibers”) are aligned along a common plane and potted (i.e. collectively sealed) at one end within a header. The technique for potting is not particularly limited but typically involves collectively sealing the ends of the fibers within a mass of potting material. Most commonly, potting is accomplished by embedding the ends of the fibers within a liquid sealant that subsequently hardens to form a tubesheet. The ends of the fibers are subsequently opened, e.g. via cutting through a section of the hardened potting material, or are otherwise temporarily sealed or protected such that liquid potting material is prevented from entering the ends of the fibers. A variety of applicable potting techniques and materials are described in the art, see for example: U.S. Pat. No. 3,708,071, U.S. Pat. No. 4,666,469, U.S. Pat. No. 5,192,478, U.S. Pat. No. 6,214,226, U.S. Pat. No. 6,290,756, U.S. Pat. No. 6,592,759, U.S. Pat. No. 6,974,554, U.S. Pat. No. 7,160,455, U.S. Pat. No. 7,344,645, U.S. Pat. No. 7,704,393 U.S. Pat. No. 7,931,805 and US2007/0158257.

The header design is not particularly limited but generally includes a housing for receiving the potted end of the tubesheet and further includes an inner permeate chamber that is in fluid communication with the lumens of the fibers. The header further includes a passageway for permeate to exit the module. Examples are provided in the previously mentioned patent references.

The selection of fiber is not particularly limited but in general, each fiber comprises an elliptical (e.g. cylindrical) porous outer structure surrounding a lumen which extends between a first and second end. The dimension of the fibers is not particularly limited. Preferred dimensions include: an outer diameter of from about 0.5 to 5 mm, an inner diameter of from about 0.5 to 2 mm and a wall thickness (i.e. porous structure between the inner and outer diameters) of from about 0.1 to 2 mm. The length of the fibers is not particularly limited and is typically dependent upon the module design. Representative lengths include those from about 0.2 to 2 m. The type of semi-permeable hollow fiber membrane is not particularly limited. Representative examples include hollow fiber membranes prepared from polysulfones, polyether sulfones, polyvinylidene fluorides (PVDF) and polyamides, commonly prepared by way of well known phase inversion processes. Additional examples include membranes made from polyolefins such as polypropylene, polyethylene and related copolymers via known etching and stretching processes. The cylindrical porous structure of the fibers is not particularly limited and may include isotropic or anisotropic structures. In preferred embodiments, the fibers are suitable for micro and ultrafiltration applications, e.g. pore sizes of from about 0.001 to 10 μm but more preferably from 0.01 to 1 μm.

The subject module further includes a plurality (e.g. 2-10) of fiber supports spaced apart and along the length of the fibers, with each fiber support comprising a frame including a plurality (e.g. 2-50, preferably 6-30) of partitions that segment the hollow fiber membranes into multiple fiber groupings (e.g. 5-500 preferably 50-200 per partition) that pass through the fiber support. In a preferred embodiment, the frame is secured along the sides of the module and extends across the path of the fibers such that the fibers pass through the partitions of the fiber support, e.g. each partition encircles a grouping of individual fibers. The shape and size of the partitions are not particularly limited, nor must the partitions be of equal size. In preferred embodiment, at least 50% and preferably at least 80% of the partitions of the fiber supports are of the same dimension. In another embodiment, the partitions are rectangular.

The module is configured such that at least a portion of the fiber groupings associated with one fiber support are distinct from those of another. In this context, the term “distinct” means that the fiber groupings are not identical. In a preferred embodiment, the fiber groupings associated with one fiber support share no more than 90%, and preferably no more than 60% of the same fibers with that of another fiber support. In another embodiment, this relationship applies to all adjacent fiber supports. In still another embodiment, the fiber groupings associated with every other (i.e. non-adjacent) fiber supports are substantially identical with each other while those directly adjacent to each other share no more than 90%, and preferably no more than 60% of the same fibers.

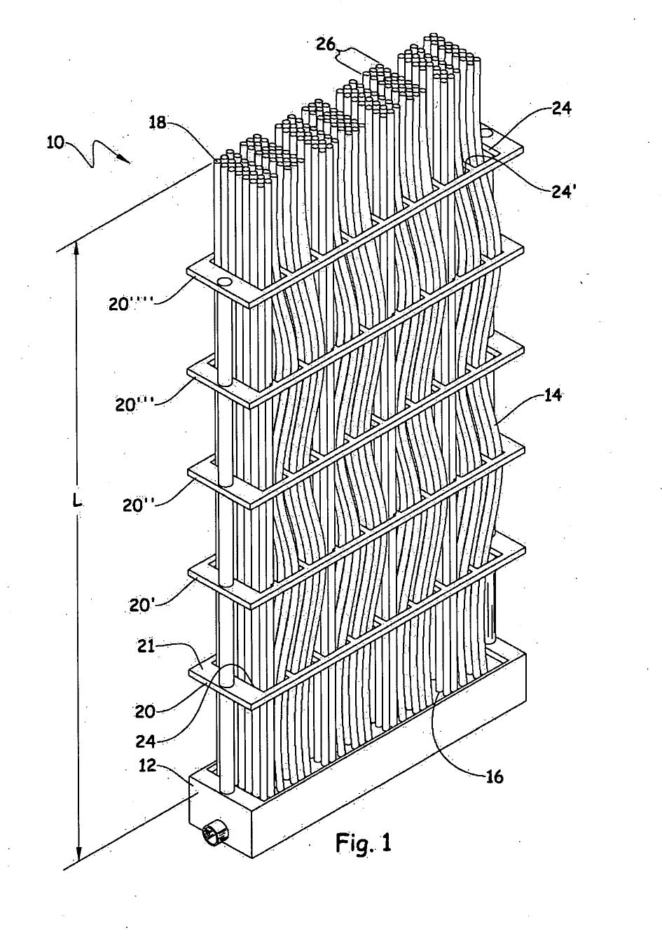

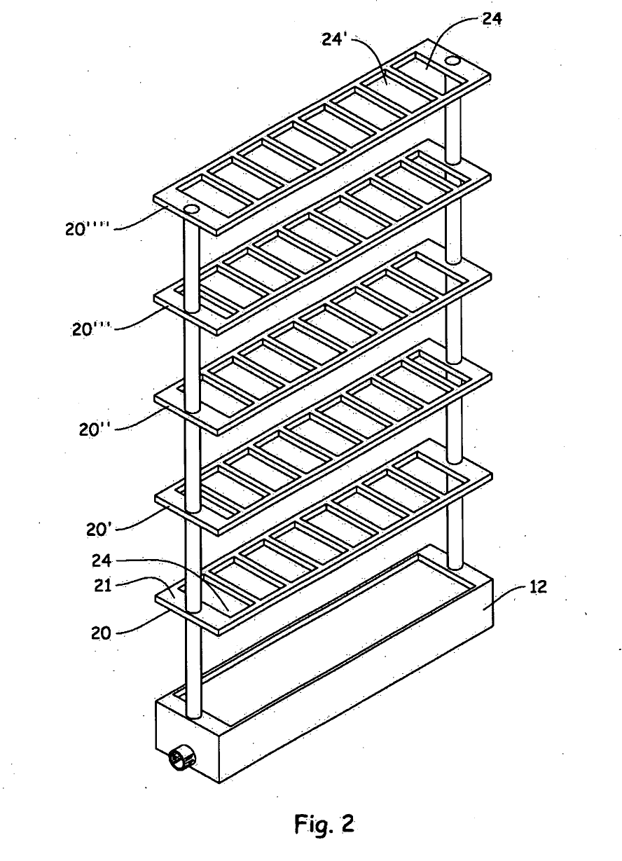

A preferred embodiment of the invention is illustrated in FIG. 1. The filtration module (10) includes a header (12) and a plurality of vertically aligned fibers (14) extending upward along a length (L) between a lower first (16) end potted within the header (12) and an upper second end (18) that is unrestrained. While not shown, the second ends of the fibers (14) are individually sealed. A plurality of fiber supports (20, 20′, 20″, 20′″, 20′″) are spaced apart along the length (L) of the fibers (14). Each fiber support (20, 20′) includes a frame (21) and a plurality of rectangular shaped partitions (24, 24′) that segment the fibers (14) into multiple fiber groupings (26) passing therethrough. At least 80% of the partitions are of equal dimension, however, the partitions of one fiber support (e.g. 20) are off-set from those of another (20′), i.e. the partitions of the fiber supports (20, 20′) are not vertically aligned. As a consequence, at least some but preferably all of the fiber groupings associated with one fiber support (20) share no more than 90%, and preferably no more than 60% of the same fibers with that of the adjacent fiber support (20′). While not shown, this technical effect may also be accomplished by using fiber support having partitions of unequal dimension, i.e. relatively small partitions in one fiber support and larger partitions in another. Alternatively, multiple size partitions may be used in each fiber support and arranged such that adjacent fiber supports unequally sized partitions are vertically aligned. This arrangement is better shown in FIG. 2 wherein the hollow fiber membranes have been removed.

While the focus of the description has been directed toward single header module designs, the subject invention is also applicable to multi-header designs along with filtration modules used in separation various fluids, e.g. gases, hydrocarbons, etc. By way of example, the invention is applicable to module designs wherein multiple headers are positioned adjacently to each other with hollow fiber membranes extending vertically upward to individually scaled ends and wherein the fibers from adjacent headers share common fiber supports along their length. By way of another example, the invention is also applicable to classic two header designs wherein hollow fibers extend between two opposing headers.

Many embodiments of the invention have been described and in some instances certain embodiments, selections, ranges, constituents, or other features have been characterized as being “preferred.” Characterizations of “preferred” features should in no way be interpreted as designated such features as being required, essential or critical to the invention. It will be understood that certain features and sub-combinations are of utility and may be employed without reference to other features and sub-combinations. References to ranges of numerical values expressly include the end points of such ranges. The entire subject matter of each patent document mentioned herein is incorporated by reference:

1. A filtration module comprising a plurality of vertically aligned semi-permeable hollow fiber membranes extending along a length between first and second ends with one of said ends potted within a header,
a plurality of fiber supports spaced apart and along the length of the hollow fiber membranes wherein each fiber support comprises a frame including a plurality of partitions that segment the hollow fiber membranes into multiple fiber groupings passing through the fiber support, and
wherein a plurality of the fiber groupings associated with at least one fiber support are distinct from those of another fiber support.

2. The filtration module of any preceding claim wherein a plurality of fiber groupings associated with at least one fiber support share no more than 90% of the same hollow fiber membranes as the fiber groupings associated with another fiber support.

3. The filtration module of any preceding claim wherein a plurality of fiber groupings associated with at least one fiber support share no more than 60% of the same hollow fiber membranes as the fiber groupings associated with another fiber support.

4. The filtration module of any preceding claim wherein the fiber groupings associated with each fiber support share no more than 90% of the same hollow fiber membranes as the fiber groupings of an adjacent fiber support.

5. The filtration module of any preceding claim wherein at least 50% of the partitions are of the same dimension.
